(19) United States
(12) Patent Application Publication
(10) Pub. No.: US 2021/0349284 A1
(43) Pub. Date: Nov. 11, 2021

(54) OPTICAL SCANNING DEVICE AND ADJUSTMENT METHOD FOR OPTICAL SCANNING DEVICE

(71) Applicant: Mitsubishi Electric Corporation, Tokyo (JP)

(72) Inventors: Yuichiro Horiguchi, Tokyo (JP); Shingo Moriue, Tokyo (JP); Hirofumi Konishi, Tokyo (JP); Yoichi Asamoto, Tokyo (JP)

(73) Assignee: Mitsubishi Electric Corporation, Tokyo (JP)

(21) Appl. No.: 17/079,780

(22) Filed: Oct. 26, 2020

(30) Foreign Application Priority Data
May 8, 2020 (JP) 2020-082373

(51) Int. Cl. G02B 7/182; G02B 26/10

(52) U.S. Cl. CPC G02B 7/1821; G02B 26/101

(57) ABSTRACT

The optical scanning device includes: a movable portion having a reflecting mirror; an intermediate frame; a support portion enclosing the intermediate frame; a first torsion bar connecting the movable portion and the intermediate frame to each other; a second torsion bar connecting the intermediate frame and the support portion to each other; a first wire formed on the movable portion; a second wire formed on the intermediate frame; a magnet; a first drive waveform generation unit configured to supply a first drive signal to the first wire; a second drive waveform generation unit configured to supply a second drive signal to the second wire; and a correction signal generation unit configured to generate a correction signal by shifting a phase of the branch-off first drive signal and multiplying an amplitude of the branch-off first drive signal by a gain, and superimpose the correction signal on the second drive signal.

### BACKGROUND OF THE INVENTION

### 1. Field of the Invention

The present disclosure relates to an optical scanning device and an adjustment method for the optical scanning device.

### 2. Description of the Background Art

In recent years, optical scanning devices that perform scanning by setting an application direction of a light beam to a desired direction have been used in the fields of video projectors and three-dimensional distance measurement. As optical scanning devices, development of MEMS (Micro Electro Mechanical Systems) mirrors in which a minute movable mirror and actuator are formed on a silicon wafer has been in progress. MEMS mirrors are required to have a structure capable of biaxial scanning in order to downsize and make inexpensive an optical system.

An example of general structures of MEMS mirrors capable of biaxial scanning is as follows. That is, a movable portion having a reflecting mirror is connected via first torsion bars to an intermediate frame, and the intermediate frame is connected via second torsion bars to a support portion enclosing these members. Each first torsion bar and each second torsion bar are perpendicular to each other, and the reflecting mirror is biaxially driven. The movable portion and the intermediate frame are respectively provided with a first wire and a second wire which have coil shapes. Current is supplied to the first wire and the second wire from the outside. Magnets are provided to the outer side of the support portion, and a magnetic field is applied in a direction at 45° with respect to the first torsion bar and the second torsion bar which are perpendicular to each other. The first torsion bar is twisted and deformed by Lorentz force due to current flowing through the first wire and the applied magnetic field, and the second torsion bar is twisted and deformed by Lorentz force due to current flowing through the second wire and the applied magnetic field. If the currents to be supplied to the wires are adjusted, the movable portion is tilted at a desired angle, and two-dimensional scanning can be performed in the output direction of a light beam reflected by the reflecting mirror.

If a first drive signal is supplied to the first wire so as to deform the first torsion bar, Lorentz force that causes rotation of the movable portion about the first torsion bar is generated at portions, of the first wire, that are parallel to the first torsion bar. At the same time, Lorentz force that causes rotation of the movable portion about the second torsion bar is generated at portions, of the first wire, that are parallel to the second torsion bar. The Lorentz force generated at the same time poses a problem of causing unnecessary deformation of the second torsion bar, thereby causing deviation from a desired trajectory of scanning. Hereinafter, force that causes unnecessary deformation of the torsion bar owing to the unnecessary Lorentz force is referred to as crosstalk. Also if a second drive signal is supplied to the second wire so as to deform the second torsion bar, unnecessary Lorentz force is generated. In view of the problem, a configuration for mechanically preventing influence of crosstalk by further separating a reflecting mirror from the location at which a first wire is provided, has been disclosed (see, for example, Patent Document 1).

Patent Document 1: Japanese Laid-Open Patent Publication No. 2009-75587

In the above-described Patent Document 1, the reflecting mirror is separated, and thus influence of crosstalk can be mechanically prevented. However, in order to separate the reflecting mirror, a space for separating the mirror is additionally needed. Thus, for providing a mirror having the same opening diameter, the size of an element is increased, and the number of elements that can be produced from one silicon wafer decreases. In addition, it is necessary to perform a step of forming a plurality of links having appropriate rigidities, and thus a manufacturing process is complicated. Therefore, increase in the size of the element and complication of the manufacturing process pose a problem in that cost for the optical scanning device increases.

### SUMMARY OF THE INVENTION

Thus, an object of the present disclosure is to obtain an optical scanning device in which crosstalk is suppressed without increasing cost for the optical scanning device.

An optical scanning device according to the present disclosure includes: a movable portion having a reflecting mirror; an intermediate frame enclosing the movable portion; a support portion enclosing the intermediate frame; a first torsion bar connecting the movable portion and the intermediate frame to each other and configured to be twisted about a first axis; a second torsion bar connecting the intermediate frame and the support portion to each other and configured to be twisted about a second axis perpendicular to the first axis; a first wire formed in a coil shape on an outer circumference of the movable portion and extended to the support portion; a second wire formed in a coil shape on the intermediate frame and extended to the support portion; a magnet configured to generate a magnetic field in a direction tilted with respect to both the first axis and the second axis; a first drive waveform generation unit configured to generate a first drive signal and supply the first drive signal to the first wire; a second drive waveform generation unit configured to generate a second drive signal and supply the second drive signal to the second wire; and a correction signal generation unit configured to cause branching of the first drive signal that is to be supplied to the first wire, generate a correction signal by shifting a phase of the branch-off first drive signal and multiplying an amplitude of the branch-off first drive signal by a gain, and superimpose the correction signal on the second drive signal that is to be supplied to the second wire.

The optical scanning device according to the present disclosure includes the correction signal generation unit configured to cause branching of the first drive signal that is to be supplied to the first wire provided to the movable portion, generate a correction signal by shifting a phase of the branch-off first drive signal and multiplying an amplitude of the branch-off first drive signal by a gain, and superimpose the correction signal on the second drive signal that is to be supplied to the second wire provided to the intermediate frame. Thus, Lorentz force can be generated so as to cancel unnecessary Lorentz force generated owing to the first drive signal. Therefore, crosstalk can be suppressed without increasing cost for the optical scanning device.

### BRIEF DESCRIPTION OF THE DRAWINGS

FIG. 1 is a perspective view schematically showing a mirror structure of an optical scanning device according to a first embodiment;

FIG. 2 is a plan view schematically showing a major part of the mirror structure of the optical scanning device according to the first embodiment;

FIG. 3 is a schematic configuration diagram of the optical scanning device according to the first embodiment;

FIG. 4A is a diagram showing waveforms of drive signals in the optical scanning device according to the first embodiment;

FIG. 4B is a diagram showing waveforms of drive signals in the optical scanning device according to the first embodiment;

FIG. 4C is a diagram showing waveforms of drive signals in the optical scanning device according to the first embodiment;

FIG. 4D is a diagram showing waveforms of drive signals in the optical scanning device according to the first embodiment;

FIG. 5 is a cross-sectional view of the mirror structure taken at the cross-sectional position A-A in FIG. 1;

FIG. 6 is a schematic configuration diagram of an optical scanning device according to a second embodiment;

FIG. 7 is a flowchart indicating a process to be performed by a correction signal control unit of the optical scanning device according to the second embodiment;

FIG. 8 is a schematic configuration diagram of an optical scanning device according to a third embodiment;

FIG. 9 is a flowchart indicating a process to be performed by the correction signal control unit of the optical scanning device according to the third embodiment;

FIG. 10 is a schematic configuration diagram of an optical scanning device according to a fourth embodiment;

FIG. 11 is a schematic configuration diagram of an optical scanning device according to a fifth embodiment;

FIG. 12 is a schematic configuration diagram of an optical scanning device in a comparative example;

FIG. 13A is a diagram showing a first drive signal in the optical scanning device in the comparative example;

FIG. 13B is a diagram showing a second drive signal in the optical scanning device in the comparative example;

FIG. 13C is a trajectory of optical scanning in the optical scanning device in the comparative example;

FIG. 14A is a perspective view schematically showing a mirror structure of an optical scanning device in the comparative example;

FIG. 14B is a diagram showing drive forces generated in the optical scanning device in the comparative example;

FIG. 14C is a diagram showing drive forces generated in the optical scanning device in the comparative example;

FIG. 15A is a diagram showing displacements about a first axis in the optical scanning device in the comparative example;

FIG. 15B is a diagram showing displacements about a second axis in the optical scanning device in the comparative example;

FIG. 15C is a trajectory of optical scanning in the optical scanning device in the comparative example; and

FIG. 16 is a configuration diagram showing an example of hardware of a control unit of the optical scanning device.

### DETAILED DESCRIPTION OF THE PREFERRED EMBODIMENTS OF THE INVENTION

Hereinafter, optical scanning devices according to embodiments of the present disclosure will be described with reference to the drawings. Description will be made while the same or corresponding members and portions in the drawings are denoted by the same reference characters.

### First Embodiment

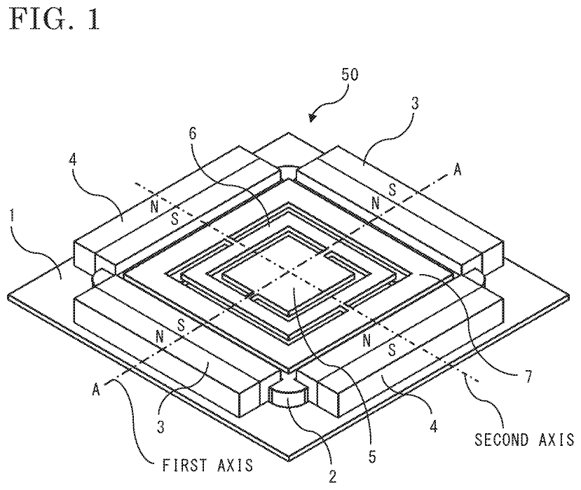

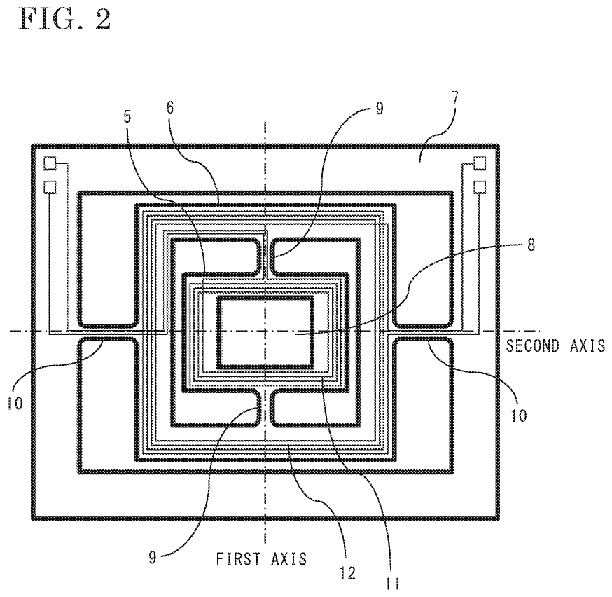

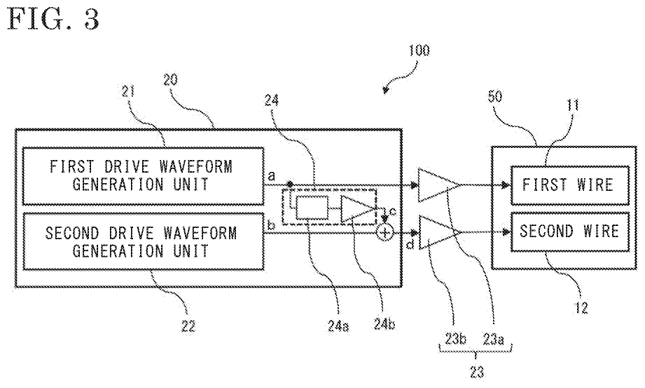

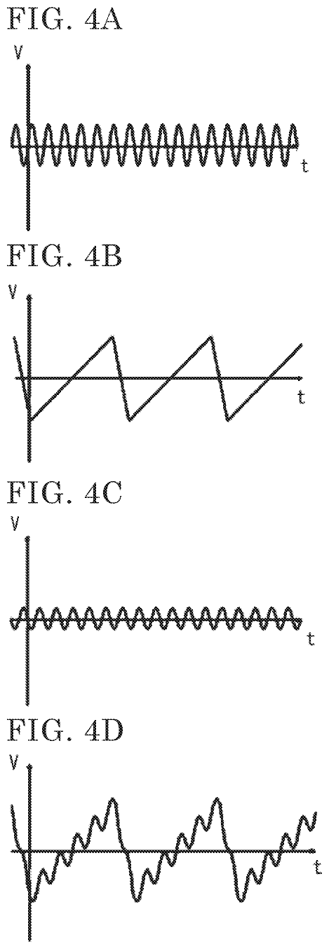

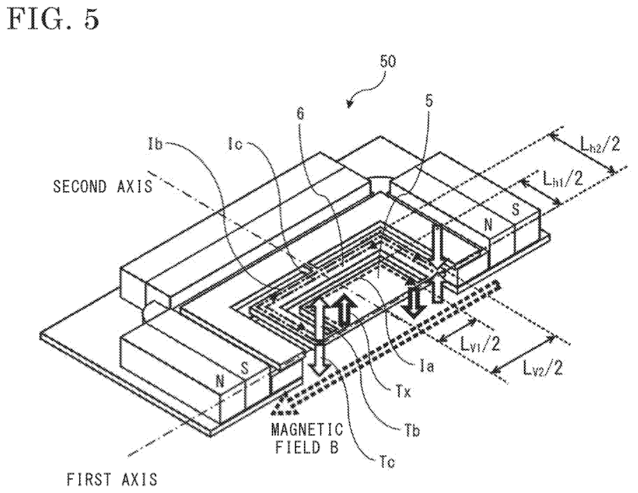

FIG. 1 is a perspective view schematically showing a mirror structure 50 of an optical scanning device 100 according to a first embodiment. FIG. 2 is a plan view schematically showing a major part of the mirror structure 50 of the optical scanning device 100. FIG. 3 is a schematic configuration diagram of the optical scanning device 100. FIG. 4A to FIG. 4D are diagrams showing waveforms of drive signals in the optical scanning device 100. FIG. 5 is a cross-sectional view of the mirror structure 50 taken at the cross-sectional position A-A in FIG. 1. The optical scanning device 100 is a device that includes the mirror structure 50 capable of biaxial scanning and a control unit 20 for controlling an operation of the mirror structure 50 and that performs scanning by setting an application direction of a light beam to a desired direction.

<Outline of Configuration of Mirror Structure 50>

As shown in FIG. 2, a major part of the mirror structure 50 includes: a movable portion 5 having a reflecting mirror 8; an intermediate frame 6 enclosing the movable portion 5; and a support portion 7 enclosing the intermediate frame 6. In addition, the mirror structure 50 further includes: first torsion bars 9 which connect the movable portion 5 and the intermediate frame 6 to each other and which are twisted about a first axis; and second torsion bars 10 which connect the intermediate frame 6 and the support portion 7 to each other and which are twisted about a second axis perpendicular to the first axis. The movable portion 5 is formed in a rectangular sheet shape having sides parallel to the first axis and sides parallel to the second axis. The intermediate frame 6 is formed in a rectangular frame sheet shape having sides parallel to the first axis and sides parallel to the second axis. The major part of the mirror structure 50 is formed of one board such as a silicon wafer by making use of micromachining technologies, for example. The support portion 7 is fixed to mechanism parts such as spacers 2, for example. The spacers 2 are fixed and retained on a board 1 such as a printed board.

As shown in FIG. 1, a pair of first magnets 3 are arranged perpendicularly to the first axis on the outer side of the support portion 7 with the support portion 7 interposed therebetween, and apply a magnetic field in the direction of the first axis. A pair of second magnets 4 are arranged perpendicularly to the second axis on the outer side of the support portion 7 with the support portion 7 interposed therebetween, and apply a magnetic field in the direction of the second axis. The first magnets 3 and the second magnets 4 are positioned and fixed on the board 1 by the spacers 2. A magnetic field is generated by the first magnets 3 and the second magnets 4 in a direction (for example, a direction at 45°) tilted with respect to both the first axis and the second axis, and the generated magnetic field is applied to the major part of the mirror structure 50.

As shown in FIG. 2, a first wire 11 is formed in a coil shape on the outer circumference of a surface of the movable portion 5 on which the reflecting mirror 8 is provided. The first wire 11 is extended through a first torsion bar 9, the intermediate frame 6, and a second torsion bar 10 to the support portion 7. A second wire 12 is formed in a coil shape on a surface of the intermediate frame 6 that is located on the same side as the surface of the movable portion 5 on which the first wire 11 is provided. The second wire 12 is extended through a second torsion bar 10 to the support portion 7. The first wire 11 and the second wire 12 are connected to a driver amplifier (not shown) provided on the board 1, so that current is supplied to the driver amplifier.

The first torsion bar 9 is twisted and deformed by Lorentz force generated by current flowing through the first wire 11 and the applied magnetic field, and the movable portion 5 rotates about the first axis with the first torsion bar 9 being the center, whereby a reflection direction of incident light is changed. The second torsion bar 10 is twisted and deformed by Lorentz force generated by current flowing through the second wire 12 and the applied magnetic field, and the movable portion 5 and the intermediate frame 6 rotate about the second axis with the second torsion bar 10 being the center, whereby the reflection direction of the incident light is changed. If the current to be supplied is adjusted, the movable portion 5 is tilted at a desired angle, and two-dimensional scanning can be performed in the output direction of the light beam reflected by the reflecting mirror 8.

### Comparative Example

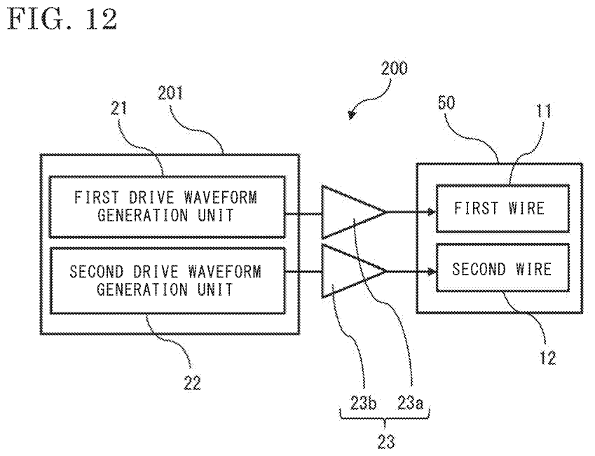

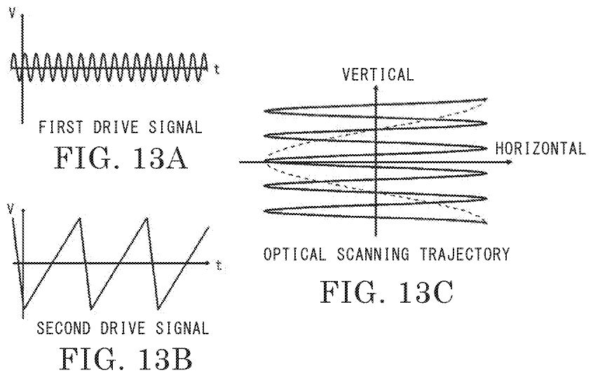

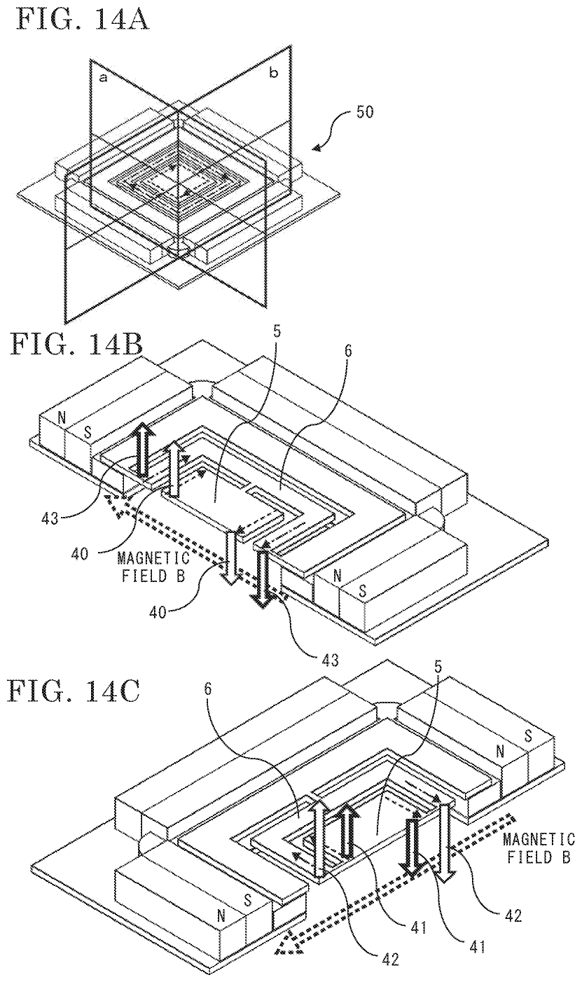

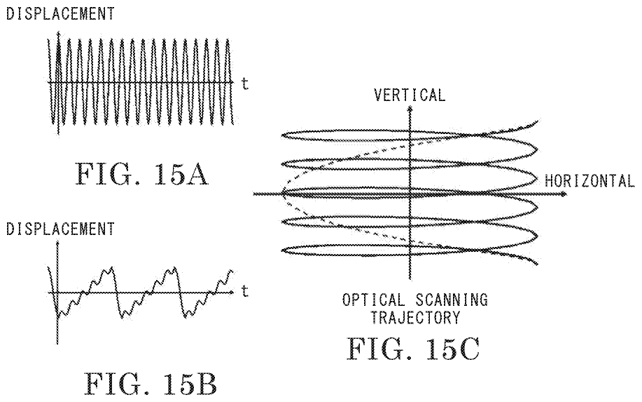

Before making description about the control unit 20 which is a major part of the present disclosure, a comparative example will be described with reference to FIG. 12 to FIG. 15C. FIG. 12 is a schematic configuration diagram of an optical scanning device 200 in the comparative example. FIG. 13A is a diagram showing a first drive signal in the optical scanning device 200 in the comparative example. FIG. 13B is a diagram showing a second drive signal in the optical scanning device 200 in the comparative example. FIG. 13C is a trajectory of optical scanning in the optical scanning device 200 in the comparative example. FIG. 14B is a diagram showing drive forces generated in the optical scanning device 200 in the comparative example. FIG. 14C is a diagram showing drive forces generated in the optical scanning device 200 in the comparative example. FIG. 15A is a diagram showing displacements about a first axis in the optical scanning device 200 in the comparative example. FIG. 15B is a diagram showing displacements about a second axis in the optical scanning device 200 in the comparative example. FIG. 15C is a trajectory of optical scanning in the optical scanning device 200 in the comparative example. A mirror structure 50 of the optical scanning device 200 in the comparative example is the same as the mirror structure 50 in FIG. 1. A control unit 201 includes: a first drive waveform generation unit 21 which generates a first drive signal for deforming the first torsion bar 9; and a second drive waveform generation unit 22 which generates a second drive signal for deforming the second torsion bar 10. These signals are supplied to the respective wires via a first driver amplifier 23a and a second driver amplifier 23b which are driver amplifiers 23. If, as shown in FIG. 13, a sine wave is supplied as the first drive signal (FIG. 13A) and a saw tooth wave is supplied as the second drive signal (FIG. 13B), it is possible to realize raster scanning in which a trajectory of a sine wave is ideally formed in the vertical direction (FIG. 13C).

Drive forces generated in the optical scanning device 200 are shown in FIG. 14B and FIG. 14C. FIG. 14A is a perspective view schematically showing a mirror structure of an optical scanning device 200 in the comparative example. FIG. 14B is a cross-sectional view along a plane (a) shown in FIG. 14A. FIG. 14C is a cross-sectional view along a plane (b) shown in FIG. 14A. When a first drive signal (the arrows illustrated with the broken lines indicated on the movable portion 5 in FIG. 14) is supplied to the first wire 11 so as to deform the first torsion bar 9, drive force 40 which is Lorentz force for rotating the movable portion 5 about the first axis is generated at portions, of the first wire 11, that are parallel to the first torsion bar 9. At the same time, unnecessary drive force 41 which is Lorentz force for rotating the movable portion 5 about the second axis is generated at portions, of the first wire 11, that are parallel to the second torsion bar 10. Hereinafter, the unnecessary drive force 41 is referred to as crosstalk. The crosstalk generated at the same time poses a problem of causing unnecessary deformation of the second torsion bar 10 (FIG. 15B), thereby causing deviation from a desired trajectory of optical scanning as shown in FIG. 15C. Also when a second drive signal (the arrows illustrated with the alternate long and short dash lines indicated on the intermediate frame 6 in FIG. 14) is supplied to the second wire 12 so as to deform the second torsion bar 10, unnecessary drive force 43 is generated in addition to desired drive force 42.

<Outline of Configuration of Control Unit 20>

The control unit 20 will be described. The control unit 20 has a function to suppress the unnecessary drive force 41. As shown in FIG. 3, the control unit 20 includes the first drive waveform generation unit 21, the second drive waveform generation unit 22, and a correction signal generation unit 24. The control unit 20 includes the correction signal generation unit 24 in addition to the constituents of the control unit 201 in the comparative example shown in FIG. 12. The first drive waveform generation unit 21 generates a first drive signal and supplies the first drive signal to the first wire 11 via the first driver amplifier 23a. The second drive waveform generation unit 22 generates a second drive signal and supplies the second drive signal to the second wire 12 via the second driver amplifier 23b. The correction signal generation unit 24 includes a phase shifter 24a for shifting the phase of a signal, and a gain adjustment part 24b for multiplying the amplitude of the signal by a gain. The correction signal generation unit 24 causes branching of the first drive signal that is to be supplied to the first wire 11, generates a correction signal by shifting the phase of the branch-off first drive signal and multiplying the amplitude of the branch-off first drive signal by a gain, and superimposes the correction signal on the second drive signal that is to be supplied to the second wire 12. By multiplication by the gain, the amplitude is increased or decreased. The driver amplifiers 23 supply, to the first wire 11 and the second wire 12, currents that are proportional to voltages of drive signals inputted to the driver amplifiers 23. Although the control unit 20 may be implemented by an analog circuit, the control unit 20 is not limited to an analog circuit and may be implemented by a logic circuit and a digital-analog converter.

Drive signals for driving the reflecting mirror 8 will be described. If a frequency component included in a drive signal is sufficiently smaller than a resonance frequency determined by a spring constant of a torsion bar and the mass of the movable portion 5 on the inner side of the torsion bar, the amount of torsion of the torsion bar (i.e., the tilt of the movable portion 5) follows the drive signal without any lag since a torque generated by Lorentz force and a torque based on the repulsive force of the torsion bar are balanced with each other. Meanwhile, if the frequency of the drive signal approaches the resonance frequency, the motion of the movable portion 5 cannot follow the drive signal, and the phase of the tilt angle of the movable portion 5 lags behind the phase of the drive frequency. At a frequency component equal to the resonance frequency, the movable portion 5 resonates to have an increased tilt angle. At this time, the phase of the tilt angle of the movable portion 5 lags behind the phase of the drive signal by 90°. In general, in a case where a wide scanning range is needed, the movable portion 5 is subjected to simple harmonic motion by using, as a drive signal, a sine wave having a frequency equal to the resonance frequency. Meanwhile, in a case where no wide scanning range is needed, the movable portion 5 is subjected to constant angular velocity motion by using, as the drive signal, a saw tooth wave having a frequency sufficiently lower than the resonance frequency. Although a case where raster scanning is performed with simple harmonic motion being caused for the first axis and with constant angular velocity motion being caused for the second axis will be described in the present embodiment, the configuration of the present disclosure is applicable also to the case of Lissajous scanning in which simple harmonic motion is caused for both axes.

A sine wave having a cycle equivalent to the resonance frequency of each of the movable portion 5 and the first torsion bar 9 is generated as the first drive signal, and a saw tooth wave having a cycle that is an integer multiple of the cycle of the first drive signal is generated as the second drive signal. If the phase of the sine wave at the start of one cycle of the saw tooth wave is set to 0° and no crosstalk is taken into account, the trajectory of optical scanning is such that the trajectory of the sine wave is set so as to originate from the upper right end of a scanning range of the mirror as shown in FIG. 13C, for example. The relationship between the positive/negative polarity of a drive signal and the upward/downward/leftward/rightward direction of the tilt of the mirror is dependent on the direction of a magnetic field, the winding direction of a wire, the configuration of the driver amplifier (inversion or non-inversion), and the like, and thus can be changed in designing. Although description will be made based on the above-described arrangement hereinafter regarding the positive/negative polarity of a drive signal, similar application can be made also in different cases by changing the positive/negative polarity of the drive signal or shifting the phase of the sine wave by 180°.

<Operation of Correction Signal Generation Unit 24>

An operation of the correction signal generation unit 24 will be described with reference to the waveforms shown in FIG. 4A to FIG. 4D, and FIG. 5. The waveforms shown in FIG. 4A to FIG. 4D are the waveforms of signals at the locations (a) to (d) indicated in FIG. 3. The waveform Sₐ of the first drive signal is expressed with expression (1) and shown in FIG. 4A.

[Mathematical 1]

Sₐ=A sin(2πft) (1)

In this case, current I_{A} supplied from the first driver amplifier 23a to the first wire 11 is expressed with expression (2).

$$\begin{matrix}[ Mathematical 2 ] & \\ {I}_{a} = \frac{{G}_{1}}{{Z}_{1}} Asin ( 2 π ft + {φ}_{1} ) & ( 2 )\end{matrix}$$

Here, G₁ represents a gain applied by the first driver amplifier 23a, Z₁ represents the impedance of the first wire 11, φ₁ represents a phase lag of current flowing through the first wire 11 relative to a voltage. In a case where the resistance of the first wire 11 is defined as R₁ and the reactance thereof is defined as Li, the impedance Z₁ of the first wire 11 and the phase lag pi are respectively expressed with expression (3) and expression (4).

$$\begin{matrix}[ Mathematical 3 ] & \\ {Z}_{1} = \sqrt{{R}_{1}^{2} + {( 2 π {fL}_{1} )}^{2}} & ( 3 ) \\ [ Mathematical 4 ] & \\ {φ}_{1} = {tan}^{- 1} ( \frac{2 π {fL}_{1}}{{R}_{1}} ) & ( 4 )\end{matrix}$$

A torque Tₓ generated about the second axis at the movable portion 5 according to crosstalk caused by the current based on the first drive signal is expressed with expression (5).

$$\begin{matrix}[ Mathematical 5 ] & \\ {T}_{x} = \frac{{L}_{v 1}}{2} {BI}_{a} {L}_{h 1} m & ( 5 )\end{matrix}$$

As shown in FIG. 5, L_{V1} represents the length of each side of the movable portion 5 parallel to the first axis, Lₕ₁ represents the length of each side of the movable portion 5 parallel to the second axis, B represents the magnitude of a magnetic field, and m represents the number of turns of a coil portion of the first wire 11.

A correction signal S_{c} generated by shifting the phase of the branch-off first drive signal and multiplying the amplitude of the branch-off first drive signal by a gain is expressed with expression (6) and shown in FIG. 4C.

[Mathematical 6]

S_{c}=G_{c}A sin(2πft+θ_{c}) (6)

Here, G_{c} represents the gain by which the amplitude has been multiplied, and θ_{c} represents the phase shift amount. The correction signal S_{c} is superimposed on the second drive signal shown in FIG. 4B, whereby a signal shown in FIG. 4D is obtained. A component Ic (the arrow illustrated with the alternate long and two short dashes line indicated on the intermediate frame 6 in FIG. 5) that is based on the correction signal and that is included in the current supplied from the second driver amplifier 23b to the second wire 12 is expressed with expression (7).

$$\begin{matrix}[ Mathematical 7 ] & \\ {I}_{C} = \frac{{G}_{C} {G}_{2}}{{Z}_{2}} Asin ( 2 π ft + {φ}_{2} + {θ}_{C} ) & ( 7 )\end{matrix}$$

Here, G₂ represents a gain applied by the second driver amplifier 23b, Z₂ represents the impedance of the second wire 12, and φ₂ represents a phase lag of current flowing through the second wire 12 relative to a voltage.

A torque T_{c} generated about the second axis at the intermediate frame 6 according to the correction current S_{c} superimposed on the second drive signal is expressed with expression (8).

$$\begin{matrix}[ Mathematical 8 ] & \\ {T}_{C} = \frac{{L}_{v 2}}{2} {BI}_{C} {L}_{h 2} n & ( 8 )\end{matrix}$$

As shown in FIG. 5, L_{V2} represents the length of each side of the intermediate frame 6 parallel to the first axis, Lₕ₂ represents the length of each side of the intermediate frame 6 parallel to the second axis, B represents the magnitude of a magnetic field, and n represents the number of turns of a coil portion of the second wire 12. If the torque Tₓ indicated in expression (5) and the torque T_{c} indicated in expression (8) are in a relationship of Tₓ=−T_{c}, the torque T_{c} based on the correction signal S_{c} and the torque Tₓ based on the crosstalk are balanced with each other. Thus, the second torsion bar 10 on the second axis is deformed only by a torque T_{b} based on the second drive signal. Therefore, the phase shift amount θ_{c} and the gain G_{c} (by which the amplitude is multiplied) which allow the torques to be balanced with each other, are expressed with expression (9) and expression (10).

$$\begin{matrix}[ Mathematical 9 ] & \\ {θ}_{C} = π + {φ}_{2} - {φ}_{1} & ( 9 ) \\ [ Mathematical 10 ] & \\ {G}_{C} = \frac{{G}_{1}}{{G}_{2}} \frac{{Z}_{2}}{{Z}_{1}} \frac{{L}_{v 1}}{{L}_{v 2}} \frac{{L}_{h 1}}{{L}_{h 2}} \frac{m}{n} & ( 10 )\end{matrix}$$

From expression (9), unnecessary Lorentz force generated owing to current flowing through the first wire 11 can be canceled by setting the phase shift amount for the correction signal to about 180°. Meanwhile, the phase of current flowing through the first wire 11 lags behind the phase of the drive signal owing to influence of the inductance of the first wire 11, and the phase of current flowing through the second wire 12 lags behind the phase of the drive signal owing to influence of the inductance of the second wire 12. Thus, if the phase shift amount for the correction signal is set to a value obtained by adding, to 180°, the difference between the amount of the phase lag of the current flowing through the first wire 11 due to the inductance of the first wire 11 and the amount of the phase lag of the current flowing through the second wire 12 due to the inductance of the second wire 12, unnecessary Lorentz force generated at the first wire 11 can be more accurately canceled.

The amplitude of the correction signal is set to an amplitude that causes generation, at the second wire 12, of a torque T_{c} equivalent to the torque Tₓ based on unnecessary Lorentz force generated at the first wire 11. Specifically, in a case where an amplification factor is same between the first driver amplifier 23a and the second driver amplifier 23b, the gain G_{c} by which the amplitude of the correction signal is multiplied may be set, according to expression (10), to a value obtained by multiplying the ratio between the number of turns of the coil portion of the first wire 11 and the number of turns of the coil portion of the second wire 12, the ratio between the length of the side of the movable portion 5 parallel to the second axis and the length of the side of the intermediate frame 6 parallel to the second axis, and the ratio between the length of the side of the movable portion 5 parallel to the first axis and the length of the side of the intermediate frame 6 parallel to the first axis, and dividing the product of the ratios by the ratio between the impedance of the first wire 11 and the impedance of the second wire 12.

As described above, the optical scanning device 100 according to the first embodiment includes the correction signal generation unit 24 which: generates a correction signal by shifting the phase of the branch-off first drive signal and multiplying the amplitude of the branch-off first drive signal by a gain; and superimposes the correction signal on the second drive signal that is to be supplied to the second wire 12. Thus, crosstalk generated owing to current flowing through the first wire 11 can be suppressed. In addition, since the correction signal generation unit 24 is provided in the control unit 20 and crosstalk can be suppressed only by changes made in the control unit 20, crosstalk can be suppressed without upsizing the mirror structure 50 and also without any increase in cost for the optical scanning device 100. In addition, in a case where a system for digitally generating a correction signal is employed, crosstalk can be easily suppressed with only a change in software without any addition in hardware.

In addition, if the phase shift amount for the correction signal is set to 180°, crosstalk which is unnecessary Lorentz force generated owing to current flowing through the first wire 11 can be canceled. In addition, if the phase shift amount for the correction signal is set to a value obtained by adding, to 180°, the difference between the amount of a phase lag of current flowing through the first wire 11 due to the inductance of the first wire 11 and the amount of a phase lag of current flowing through the second wire 12 due to the inductance of the second wire 12, crosstalk which is unnecessary Lorentz force generated owing to the current flowing through the first wire 11 can be more accurately canceled. In addition, if the gain by which the amplitude of the correction signal is multiplied is set to a value obtained by multiplying the ratio between the number of turns of the coil portion of the first wire 11 and the number of turns of the coil portion of the second wire 12, the ratio between the length of the side of the movable portion 5 parallel to the second axis and the length of the side of the intermediate frame 6 parallel to the second axis, and the ratio between the length of the side of the movable portion 5 parallel to the first axis and the length of the side of the intermediate frame 6 parallel to the first axis, and dividing the product of the ratios by the ratio between the impedance of the first wire 11 and the impedance of the second wire 12, crosstalk which is unnecessary Lorentz force generated owing to the current flowing through the first wire 11 can be more accurately canceled.

### Second Embodiment

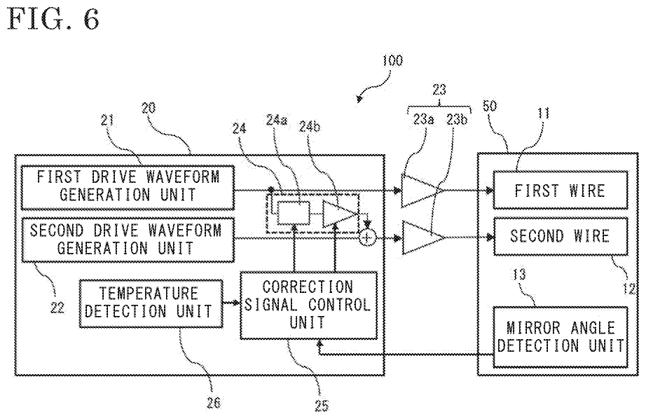

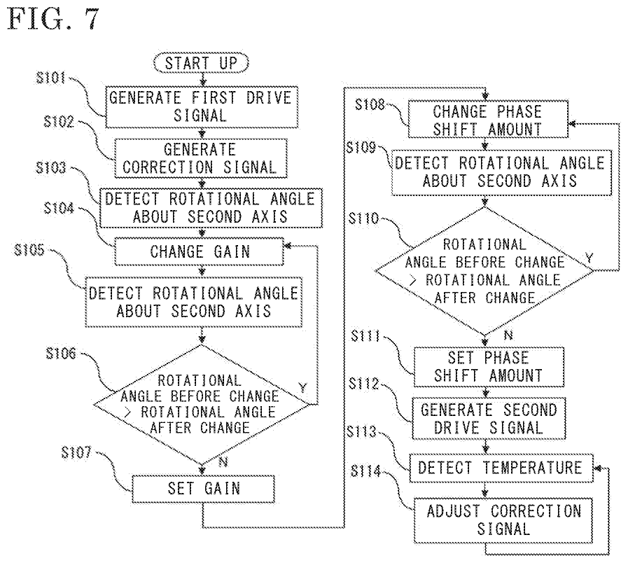

An optical scanning device 100 according to a second embodiment will be described. FIG. 6 is a schematic configuration diagram of the optical scanning device 100 according to the second embodiment. FIG. 7 is a flowchart indicating a process to be performed by a correction signal control unit 25 of the optical scanning device 100. The optical scanning device 100 according to the second embodiment is configured to adjust the phase shift amount and the gain for the correction signal on the basis of a rotational angle of the movable portion 5.

The mirror structure 50 includes a mirror angle detection unit 13 which detects and outputs the rotational angle of the movable portion 5. A piezoresistor is provided near the first torsion bar 9 and the second torsion bar 10, and the amount of torsion of each of these torsion bars is detected from a change in the resistance of the piezoresistor, whereby a rotational angle can be detected. The means for detecting the rotational angle is not limited to the piezoresistor, and the rotational angle may be detected on the basis of a change, in a capacitance, that occurs according to the distance between the board and the rear surface of the movable portion 5. Alternatively, a part of scanning light may be caused to branch off and to be incident on a photodetector so that the rotational angle is detected from a change in the location at which the light is incident.

The control unit 20 includes: the correction signal control unit 25 which adjusts, on the basis of the detected rotational angle, the phase shift amount for the correction signal and the gain by which the amplitude of the correction signal is multiplied; and a temperature detection unit 26 which detects and outputs the temperature of the optical scanning device 100. The hardware constituting the control unit 20 contains data of temperature characteristics of reactances and resistances of the first wire 11 and the second wire 12.

An example of a process to be performed by the correction signal control unit 25 on the basis of the detected rotational angle will be described with reference to FIG. 7. Here, the correction signal control unit 25 adjusts the gain for the correction signal first, and then adjusts the phase shift amount for the correction signal. However, the order of the adjustments is not limited thereto. When the optical scanning device 100 is started up, the control unit 20 generates and outputs only a first drive waveform by means of the first drive waveform generation unit 21 (step S101). The correction signal generation unit 24 generates a correction signal in an initial setting state (step S102). Initial setting values for the correction signal may be predetermined or may be a phase shift amount and a gain used at the previous time of start-up of the optical scanning device 100. Next, the mirror angle detection unit 13 detects a rotational angle about the second axis (step S103). Next, the gain adjustment part 24b changes the gain in a predetermined step on the basis of a command from the correction signal control unit 25 (step S104), and the mirror angle detection unit 13 detects a rotational angle about the second axis after the change in the gain (step S105). The correction signal control unit 25 performs comparison between the rotational angle before the change in the gain and the rotational angle after the change in the gain, and, while checking increase and decrease in the rotational angle, keeps changing the gain until the rotational angle becomes minimum, thereby obtaining a gain at which a displacement amount becomes minimum (step S106). The correction signal control unit 25 sets, as the gain for the correction signal, the gain at which the displacement amount has become minimum (step S107).

Next, the phase shift amount for the correction signal is adjusted. The phase shifter 24a changes the phase shift amount in a predetermined step on the basis of a command from the correction signal control unit 25 (step S108), and the mirror angle detection unit 13 detects a rotational angle about the second axis after the change in the phase shift amount (step S109). The correction signal control unit 25 performs comparison between the rotational angle before the change in the phase shift amount and the rotational angle after the change in the phase shift amount, and, while checking increase and decrease in the rotational angle, keeps changing the phase shift amount until the rotational angle becomes minimum, thereby obtaining a phase shift amount at which a displacement amount becomes minimum (step S110). The correction signal control unit 25 sets, as the phase shift amount for the correction signal, the phase shift amount at which the displacement amount has become minimum (step S111). The steps performed thus far allow setting of an amplitude and a phase, for the correction signal, at which an unnecessary motion due to crosstalk about the second axis takes a minimum value. Then, the control unit 20 generates a second drive waveform by means of the second drive waveform generation unit 22 and starts optical scanning (step S112).

In addition to the process based on the detected rotational angle, the correction signal control unit 25 may further adjust the phase shift amount and the gain on the basis of a temperature detected by the temperature detection unit 26. A process based on a temperature will be described. The temperature detection unit 26 detects the temperature of the optical scanning device 100 (step S113). The correction signal control unit 25 corrects, from the detected temperature and the data of the temperature characteristics of the resistances and the reactances of the first wire 11 and the second wire 12 contained in advance, the values of the resistances and the reactances of the first wire 11 and the second wire 12 to adjust the phase shift amount and the gain for the correction signal (step S114). The adjustment, of the phase shift amount and the gain, that is based on the temperature is repeatedly performed during an operation of the optical scanning device 100.

As described above, the optical scanning device 100 according to the second embodiment includes: the mirror angle detection unit 13 which detects and outputs a rotational angle; and the correction signal control unit 25 which adjusts the phase shift amount and the gain for the correction signal on the basis of the rotational angle. Accordingly, crosstalk generated owing to current flowing through the first wire 11 can be suppressed even if temporal changes occur in the first wire 11, the second wire 12, and the like of the mirror structure 50. In addition, in a case where the correction signal control unit 25 adjusts the phase shift amount and the gain on the basis of a rotational angle, about the second axis, that is obtained at the time of supply of the first drive signal to the first wire 11, the phase shift amount and the gain are adjusted at the time of start-up of the optical scanning device 100, whereby crosstalk generated owing to current flowing through the first wire 11 can be suppressed. Therefore, crosstalk generated owing to current flowing through the first wire 11 can be suppressed from the beginning when the start-up is performed.

In addition, in a case where the correction signal control unit 25 adjusts the phase shift amount and the gain on the basis of a temperature, crosstalk generated owing to current flowing through the first wire 11 can be suppressed even if the temperatures of the first wire 11 and the second wire 12 change. In addition, the mirror angle detection unit 13 and the temperature detection unit 26 of the optical scanning device 100 are generally provided to optical scanning devices in order to control an emission timing and an emission output of transmission light. Thus, by using the mirror angle detection unit 13 and the temperature detection unit 26 which have been already provided, crosstalk can be suppressed without increasing cost for the optical scanning device 100.

### Third Embodiment

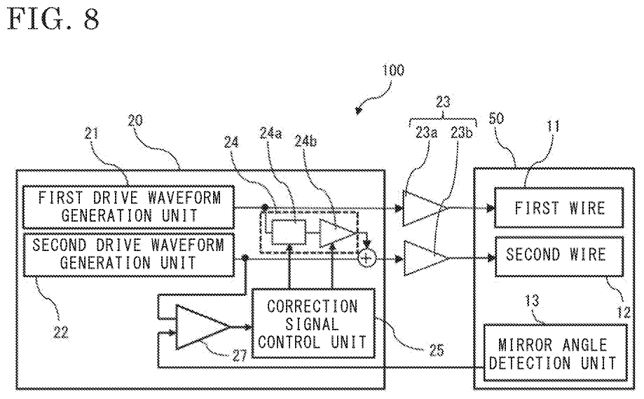

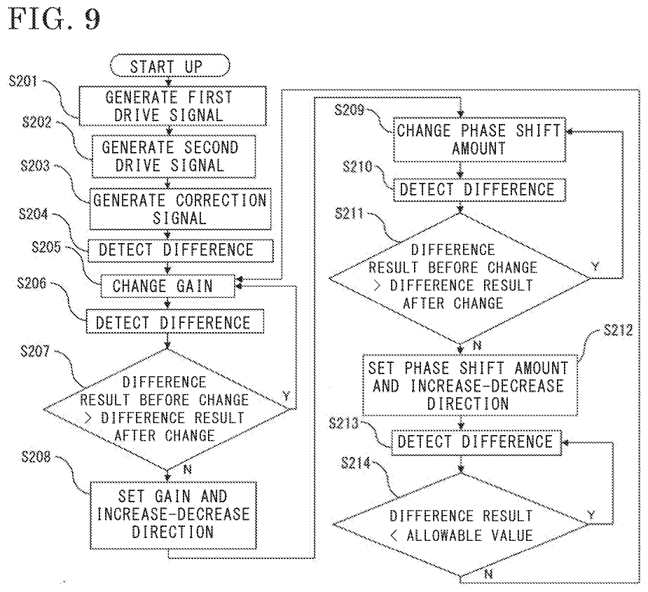

An optical scanning device 100 according to a third embodiment will be described. FIG. 8 is a schematic configuration diagram of the optical scanning device 100 according to the third embodiment. FIG. 9 is a flowchart indicating a process to be performed by the correction signal control unit 25 of the optical scanning device 100. The optical scanning device 100 according to the third embodiment is configured to adjust the phase shift amount and the gain for the correction signal on the basis of an output from a differential amplifier 27.

The control unit 20 includes, in addition to the constituents described in the second embodiment, the differential amplifier 27 which outputs a signal according to the difference between the branch-off second drive signal and a rotational angle about the second axis detected by the mirror angle detection unit 13. The correction signal control unit 25 adjusts the phase shift amount and the gain for the correction signal on the basis of the output from the differential amplifier 27.

An example of a process to be performed by the correction signal control unit 25 on the basis of the output from the differential amplifier 27 will be described with reference to FIG. 9. Here, the correction signal control unit 25 adjusts the gain for the correction signal first, and then adjusts the phase shift amount for the correction signal. However, the order of the adjustments is not limited thereto. When the optical scanning device 100 is started up, the control unit 20 generates and outputs a first drive waveform by means of the first drive waveform generation unit 21 (step S201) and generates and outputs a second drive waveform by means of the second drive waveform generation unit 22 (step S202). The correction signal generation unit 24 generates a correction signal in an initial setting state (step S203). Initial setting values for the correction signal may be predetermined or may be a phase shift amount and a gain used at the previous time of start-up of the optical scanning device 100. Next, the differential amplifier 27 detects the difference between the branch-off second drive signal and a rotational angle about the second axis detected by the mirror angle detection unit 13, and outputs a signal according to the difference (step S204). Next, the gain adjustment part 24b changes the gain in a predetermined step on the basis of a command from the correction signal control unit 25 (step S205), and the differential amplifier 27 detects a difference after the change in the gain, and outputs a signal according to the difference (step S206). The gain may be changed so as to increase or decrease. The correction signal control unit 25 performs comparison between the difference result before the change in the gain and the difference result after the change in the gain. If the difference result after the change is equal to or smaller than the difference result before the change, the correction signal control unit 25 changes the gain and repeats comparison between the difference results (step S207). If the difference result after the change becomes larger than the difference result before the change, the correction signal control unit 25 breaks away from the repetition loop, updates the gain for the correction signal, and sets a change in the increase-decrease direction of a gain change value, and the process proceeds to the next step (step S208).

Next, the phase shift amount for the correction signal is adjusted. The phase shifter 24a changes the phase shift amount in a predetermined step on the basis of a command from the correction signal control unit 25 (step S209), and the differential amplifier 27 detects a difference after the change in the phase shift amount and outputs a signal according to the difference (step S210). The correction signal control unit 25 performs comparison between the difference result before the change in the phase shift amount and the difference result after the change in the phase shift amount. If the difference result after the change is equal to or smaller than the difference result before the change, the correction signal control unit 25 changes the phase shift amount and repeats comparison between the difference results (step S211). If the difference result after the change becomes larger than the difference result before the change, the correction signal control unit 25 breaks away from the repetition loop, updates the phase shift amount for the correction signal, and sets a change in the increase-decrease direction of a phase shift amount change value, and the process proceeds to the next step (step S212).

Lastly, the correction signal control unit 25 acquires, from the differential amplifier 27, the result of the detection of the difference between the branch-off second drive signal and the rotational angle about the second axis (step S213), and checks whether the result is equal to or smaller than a predetermined allowable value. If the result is equal to or smaller than the allowable value, the correction signal control unit 25 repeats the result acquisition. If the result exceeds the allowable value, the process returns to the setting update (step S205) of the gain for the correction signal (step S214). The increase-decrease direction of the gain change value in step S205 is set to be the direction that has been set in step S208. The increase-decrease direction of the phase shift amount change value in step S209 is set to be the direction that has been set in step S212.

As described above, in the optical scanning device 100 according to the third embodiment, the differential amplifier 27 outputs a signal according to the difference between the branch-off second drive signal and the rotational angle about the second axis, and the correction signal control unit 25 adjusts the phase shift amount and the gain on the basis of the output from the differential amplifier 27. Accordingly, crosstalk generated owing to current flowing through the first wire 11 can be suppressed while the optical scanning device 100 is being driven.

### Fourth Embodiment

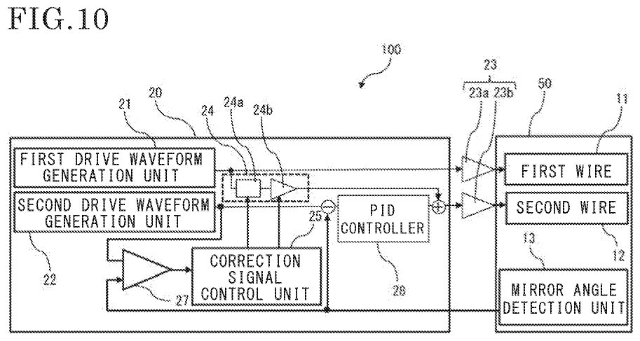

An optical scanning device 100 according to a fourth embodiment will be described. FIG. 10 is a schematic configuration diagram of the optical scanning device 100 according to the fourth embodiment. The optical scanning device 100 according to the fourth embodiment has a configuration in which the control unit 20 includes a PID controller 28.

The control unit 20 includes, in addition to the constituents described in the third embodiment, the PID controller 28 which outputs an operation amount generated by performing PID control according to the difference value between the second drive signal and a rotational angle about the second axis. With the second drive signal being a target value and with the rotational angle about the second axis being a feedback signal, PID control is performed on the difference value between these two. An operation amount generated through a proportional control unit, an integral control unit, and a differential control unit which perform PID control is outputted from the PID controller 28, and the correction signal generation unit 24 superimposes the correction signal on the operation amount outputted by the PID controller 28.

As described above, in the optical scanning device 100 according to the fourth embodiment, the PID controller 28 outputs an operation amount generated by performing PID control according to the difference value between the second drive signal and the rotational angle about the second axis, and the correction signal generation unit 24 superimposes the correction signal on the operation amount. Accordingly, even under the condition that an unnecessary motion about the second axis due to a factor which excludes crosstalk and examples of which include disturbance vibrations and the like occurs, the unnecessary motion about the second axis due to the factor which excludes crosstalk is suppressed by the PID control, and crosstalk generated owing to current flowing through the first wire 11 can also be suppressed.

### Fifth Embodiment

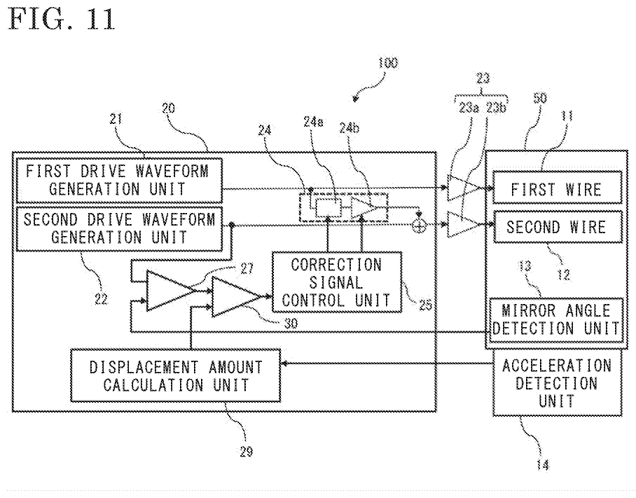

An optical scanning device 100 according to a fifth embodiment will be described. FIG. 11 is a schematic configuration diagram of the optical scanning device 100 according to the fifth embodiment. The optical scanning device 100 according to the fifth embodiment includes, in addition to the constituents described in the third embodiment, an acceleration detection unit 14 and has a configuration in which the control unit 20 includes a displacement amount calculation unit 29 and a second differential amplifier 30.

The optical scanning device 100 includes the acceleration detection unit 14 which detects and outputs an acceleration that is applied to the optical scanning device 100. The acceleration detection unit 14 is an MEMS (Micro Electro Mechanical Systems) acceleration detector produced by making use of micromachining technologies, for example. If the acceleration detection unit 14 is a small-sized MEMS acceleration detector, the acceleration detection unit 14 may be mounted on the board 1 or may be integrated on the mirror structure 50.

The control unit 20 includes the displacement amount calculation unit 29 and the second differential amplifier 30 in addition to the constituents described in the third embodiment. The displacement amount calculation unit 29 calculates an angular displacement amount of the movable portion 5 about the second axis on the basis of the acceleration outputted from the acceleration detection unit 14, a spring constant of the second torsion bar, and the mass of the movable portion 5, and outputs the angular displacement amount. The second differential amplifier 30 outputs a signal according to the difference between the output from the differential amplifier 27 and the angular displacement amount outputted from the displacement amount calculation unit 29.

A process to be performed by the correction signal control unit 25 on the basis of an output from the second differential amplifier 30 will be described. The acceleration outputted from the acceleration detection unit 14 is an acceleration based on a disturbance applied to the optical scanning device 100. The angular displacement amount of the movable portion 5 outputted from the displacement amount calculation unit 29 is the angular displacement of the movable portion 5 rotated according to the acceleration based on the disturbance. The correction signal control unit 25 adjusts the phase shift amount and the gain for the correction signal on the basis of the result of the difference between the output from the differential amplifier 27 and the angular displacement of the movable portion 5 based on the disturbance. The result is the output from the second differential amplifier 30. By this configuration, even under the condition that an unnecessary motion about the second axis due to a factor which excludes crosstalk and which is a disturbance such as vibrations occurs, the unnecessary motion about the second axis due to the factor which excludes crosstalk can be separated and suppressed.

As described above, the optical scanning device 100 according to the fifth embodiment includes: the acceleration detection unit 14 which detects and outputs an acceleration that is applied to the optical scanning device 100; the displacement amount calculation unit 29 which calculates an angular displacement amount of the movable portion 5 about the second axis on the basis of the acceleration, a spring constant of the second torsion bar 10, and the mass of the movable portion 5; and the second differential amplifier 30 which outputs a signal according to the difference between the output from the differential amplifier 27 and the angular displacement amount. In addition, the correction signal control unit 25 adjusts the phase shift amount and the gain for the correction signal on the basis of the output from the second differential amplifier 30. Accordingly, even under the condition that a disturbance such as vibrations occurs, an unnecessary motion about the second axis due to the factor which excludes crosstalk can be separated and suppressed, and crosstalk generated owing to current flowing through the first wire 11 can also be suppressed.

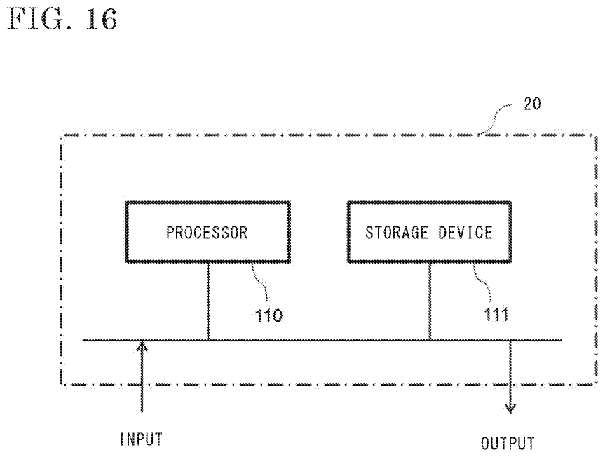

As shown in FIG. 16, an example of hardware of the control unit 20 of the optical scanning device 100 is composed of a processor 110 and a storage device 111. Although not shown, the storage device includes a volatile storage device such as a random access memory, and a nonvolatile auxiliary storage device such as a flash memory. Alternatively, the storage device may include, as the auxiliary storage device, a hard disk instead of a flash memory. The processor 110 executes a program inputted from the storage device 111. In this case, the program is inputted from the auxiliary storage device via the volatile storage device to the processor 110. In addition, the processor 110 may output data such as a calculation result to the volatile storage device of the storage device 111 or may save the data via the volatile storage device to the auxiliary storage device.

Although the disclosure is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations to one or more of the embodiments of the disclosure.

It is therefore understood that numerous modifications which have not been exemplified can be devised without departing from the scope of the specification of the present disclosure. For example, at least one of the constituent components may be modified, added, or eliminated. At least one of the constituent components mentioned in at least one of the preferred embodiments may be selected and combined with the constituent components mentioned in another preferred embodiment.

### DESCRIPTION OF THE REFERENCE CHARACTERS

1 board
2 spacer
3 first magnet
4 second magnet
5 movable portion
6 intermediate frame
7 support portion
8 reflecting mirror
9 first torsion bar
10 second torsion bar
11 first wire
12 second wire
13 mirror angle detection unit
14 acceleration detection unit
20 control unit
21 first drive waveform generation unit
22 second drive waveform generation unit
23 driver amplifier
23a first driver amplifier
23b second driver amplifier
24 correction signal generation unit
24a phase shifter
24b gain adjustment part
25 correction signal control unit
26 temperature detection unit
27 differential amplifier
28 PID controller
29 displacement amount calculation unit
30 second differential amplifier
40 drive force
41 unnecessary drive force
42 drive force
43 unnecessary drive force
50 mirror structure
100 optical scanning device
110 processor
111 storage device
200 optical scanning device
201 control unit

What is claimed is:

1. An optical scanning device comprising: a movable portion having a reflecting mirror; an intermediate frame enclosing the movable portion; a support portion enclosing the intermediate frame; a first torsion bar connecting the movable portion and the intermediate frame to each other and configured to be twisted about a first axis; a second torsion bar connecting the intermediate frame and the support portion to each other and configured to be twisted about a second axis perpendicular to the first axis; a first wire formed in a coil shape on an outer circumference of the movable portion and extended to the support portion; a second wire formed in a coil shape on the intermediate frame and extended to the support portion; a magnet configured to generate a magnetic field in a direction tilted with respect to both the first axis and the second axis;
a first drive waveform generator configured to generate a first drive signal and supply the first drive signal to the first wire;
a second drive waveform generator configured to generate a second drive signal and supply the second drive signal to the second wire; and
a correction signal generator configured to cause branching of the first drive signal that is to be supplied to the first wire, generate a correction signal by shifting a phase of the branch-off first drive signal and multiplying an amplitude of the branch-off first drive signal by a gain, and superimpose the correction signal on the second drive signal that is to be supplied to the second wire.

2. The optical scanning device according to claim 1, wherein a phase shift amount for the correction signal is 1800.

3. The optical scanning device according to claim 1, wherein a phase shift amount for the correction signal is a value obtained by adding, to 180°, a difference between an amount of a phase lag of current flowing through the first wire due to an inductance of the first wire and an amount of a phase lag of current flowing through the second wire due to an inductance of the second wire.

4. The optical scanning device according to claim 1, wherein
the movable portion is formed in a rectangular sheet shape having a side parallel to the first axis and a side parallel to the second axis,
the intermediate frame is formed in a rectangular frame sheet shape having a side parallel to the first axis and a side parallel to the second axis, and
the gain is a value obtained by
multiplying a ratio between a number of turns of a coil portion of the first wire and a number of turns of a coil portion of the second wire, a ratio between a length of the side of the movable portion parallel to the second axis and a length of the side of the intermediate frame parallel to the second axis, and a ratio between a length of the side of the movable portion parallel to the first axis and a length of the side of the intermediate frame parallel to the first axis, and
dividing a product of the ratios by a ratio between an impedance of the first wire and an impedance of the second wire.

5. The optical scanning device according to claim 1, further comprising:
a mirror angle detector configured to detect and output a rotational angle of the movable portion; and
a correction signal controller configured to adjust a phase shift amount and the gain for the correction signal on the basis of the rotational angle.

6. The optical scanning device according to claim 5, wherein the correction signal controller adjusts the phase shift amount and the gain on the basis of the rotational angle, about the second axis, that is obtained at a time of supply of the first drive signal to the first wire.

7. The optical scanning device according to claim 5, further comprising a temperature detector configured to detect and output a temperature of the optical scanning device, wherein
the correction signal controller adjusts the phase shift amount and the gain on the basis of the temperature.

8. The optical scanning device according to claim 6, further comprising a temperature detector configured to detect and output a temperature of the optical scanning device, wherein
the correction signal controller adjusts the phase shift amount and the gain on the basis of the temperature.

9. The optical scanning device according to claim 1, further comprising:
a mirror angle detector configured to detect and output a rotational angle of the movable portion;
a differential amplifier configured to output a signal according to a difference between the branch-off second drive signal and the rotational angle about the second axis; and
a correction signal controller configured to adjust a phase shift amount and the gain on the basis of the output from the differential amplifier.

10. The optical scanning device according to claim 9, further comprising a PID controller configured to output an operation amount generated by performing PID control according to a difference value between the second drive signal and the rotational angle about the second axis, wherein
the correction signal generator superimposes the correction signal on the operation amount.

11. The optical scanning device according to claim 9, further comprising:
an acceleration detector configured to detect and output an acceleration that is applied to the optical scanning device;
a displacement amount calculator configured to calculate an angular displacement amount of the movable portion about the second axis on the basis of the acceleration, a spring constant of the second torsion bar, and a mass of the movable portion; and
a second differential amplifier configured to output a signal according to a difference between the output from the differential amplifier and the angular displacement amount, wherein
the correction signal controller adjusts the phase shift amount and the gain on the basis of the output from the second differential amplifier.

12. An adjustment method for an optical scanning device including: a movable portion having a reflecting mirror; an intermediate frame enclosing the movable portion; a support portion enclosing the intermediate frame; a first torsion bar connecting the movable portion and the intermediate frame to each other and configured to be twisted about a first axis; a second torsion bar connecting the intermediate frame and the support portion to each other and configured to be twisted about a second axis perpendicular to the first axis; a first wire formed in a coil shape on an outer circumference of the movable portion and extended to the support portion; a second wire formed in a coil shape on the intermediate frame and extended to the support portion; a magnet configured to generate a magnetic field in a direction tilted with respect to both the first axis and the second axis;
a first drive waveform generator configured to generate a first drive signal and supply the first drive signal to the first wire;
a second drive waveform generator configured to generate a second drive signal and supply the second drive signal to the second wire;
a correction signal generator configured to cause branching of the first drive signal that is to be supplied to the first wire, generate a correction signal by shifting a phase of the branch-off first drive signal and multiplying an amplitude of the branch-off first drive signal by a gain, and superimpose the correction signal on the second drive signal that is to be supplied to the second wire;
a mirror angle detector configured to detect and output a rotational angle of the movable portion; and
a correction signal controller configured to adjust a phase shift amount and the gain for the correction signal on the basis of the rotational angle,
the adjustment method comprising
a step of generating a first drive waveform,
a step of generating a correction signal in a predetermined initial setting state,
a step of detecting a rotational angle about the second axis,
a step of changing a gain on the basis of a command from the correction signal controller,
a step of detecting a rotational angle about the second axis after the change in the gain,
a step of performing comparison between the rotational angle before the change in the gain and the rotational angle after the change in the gain, and, while checking increase and decrease in the rotational angle, keeping changing the gain until the rotational angle becomes minimum, to obtain a gain at which a displacement amount becomes minimum,
a step of setting, as the gain for the correction signal, the gain at which the displacement amount has become minimum,
a step of changing a phase shift amount on the basis of a command from the correction signal controller,
a step of detecting a rotational angle about the second axis after the change in the phase shift amount,
a step of performing comparison between the rotational angle before the change in the phase shift amount and the rotational angle after the change in the phase shift amount, and, while checking increase and decrease in the rotational angle, keeping changing the phase shift amount until the rotational angle becomes minimum, to obtain a phase shift amount at which a displacement amount becomes minimum, and
a step of setting, as the phase shift amount for the correction signal, the phase shift amount at which the displacement amount has become minimum.
